(19) United States
(12) Patent Application Publication
(10) Pub. No.: US 2020/0315387 A1
(43) Pub. Date: Oct. 8, 2020

(54) COOKING UTENSIL

(71) Applicants: Dusko MARAVIC, (US); CONDECO TECHNOLOGIES AG, Basel (CH)

(72) Inventor: Dusko MARAVIC, Basel (CH)

(21) Appl. No.: 16/305,651

(22) PCT Filed: Jun. 6, 2017
(86) PCT No.: PCT/IB2017/000715

§ 371 Date: Nov. 29, 2018

(30) Foreign Application Priority Data
Jun. 6, 2016 (CH) 00718/16

(51) Int. Cl. A47J 27/00; A47J 36/02; A47J 36/32

(52) U.S. Cl. CPC A47J 27/002; A47J 2202/00; A47J 36/32; A47J 36/02

(57) ABSTRACT

A double-walled cooking utensil having an inner body and an outer body, which are arranged at a distance inside one another, as well as a flat base region and a wall region. A bottom plate is arranged in the base region between the two bodies. The two bodies are connected to one another in a vacuum-tight manner and a vacuum exists between them. In a preferred embodiment, the base region of the outer body has a recess, into which an additional bottom plate is inserted in a vacuum-tight manner. The production takes place in a vacuum chamber or a vacuum is subsequently generated.

The invention is related with a cooking vessel according to the preamble of claim 1 and a method of producing it.

Nowadays most cooking utensils made of high-grade steel are provided with a so-called sandwich base. The technologies applied therefor exclusively include material bonding which is achieved by soldering or so-called beating. In both cases quite high temperatures have to be achieved, so that a secure connection is generated. Usually a sandwich base consists of an aluminum disc and a so-called capsule which are connected to each other by one of the procedures mentioned above. In other words, the contacting surfaces are connected by a so-called mediation. In the case of soldering this mediation is the suitable solder and in case of the so-called beating it is the atomic bonding forces which hold together the two materials. Nowadays, for obtaining a sandwich base a relatively high energy consumption is required.

The invention is based upon the problem to find a cooking vessel with a better base construction and a method for its production.

According to the invention this problem is solved by the features of the body of claims 1, 7 and 8.

In the following preferred embodiments of the invention are described withreference to the accompanying drawings. It is shown in

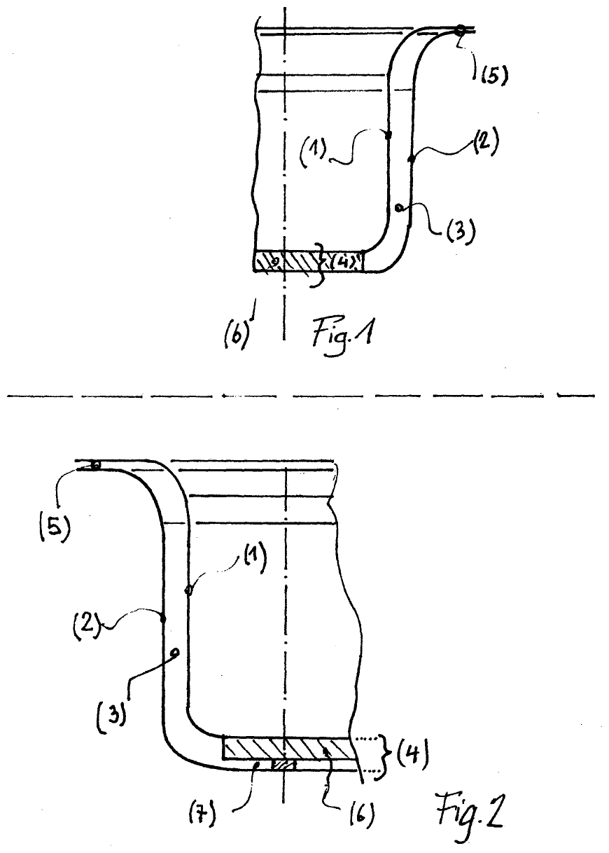

FIG. 1 a schematic cross-sectional view of a cooking vessel according to the invention,

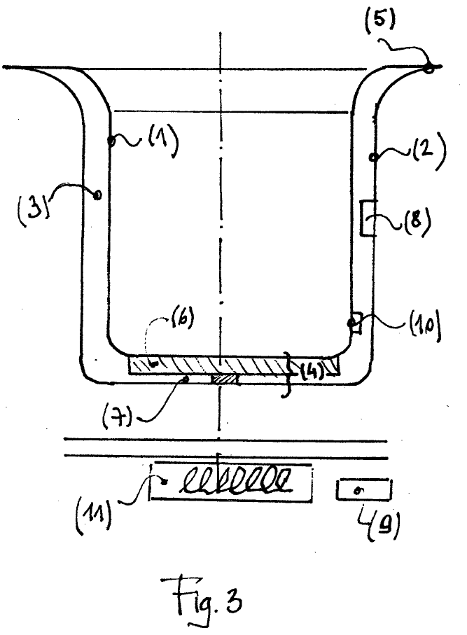

FIG. 2 a schematic cross-sectional view of an alternative embodiment,

FIG. 3 an embodiment with means for a temperature control,

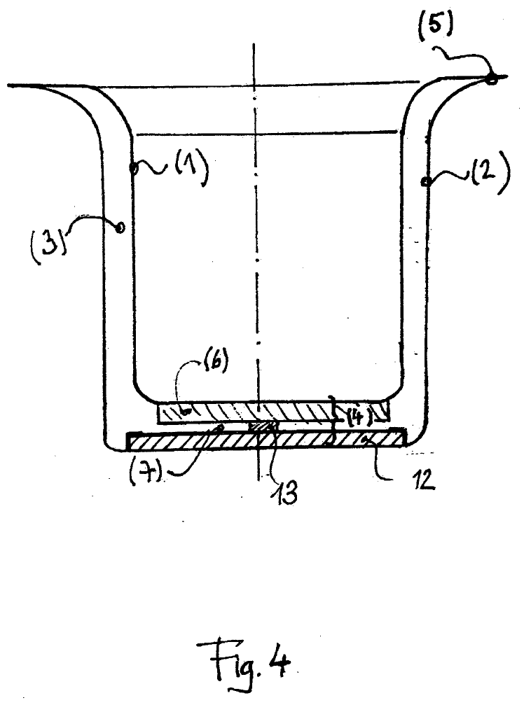

FIG. 4 a schematic cross-sectional view of a further alternative embodiment,

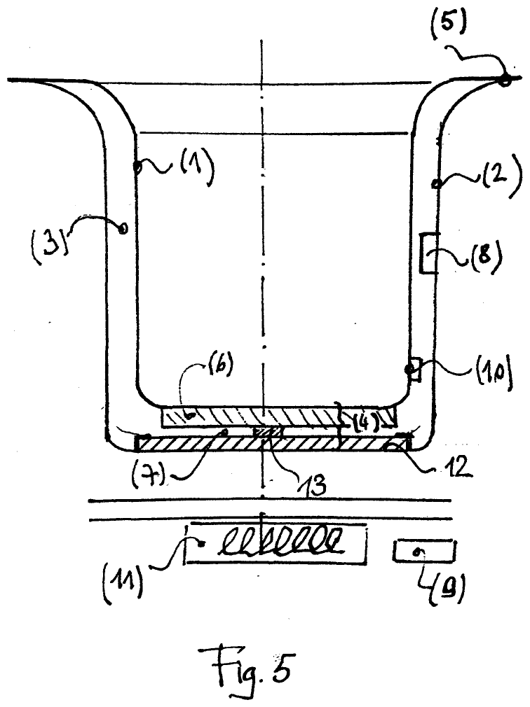

FIG. 5 a further embodiment with means for a temperature control,

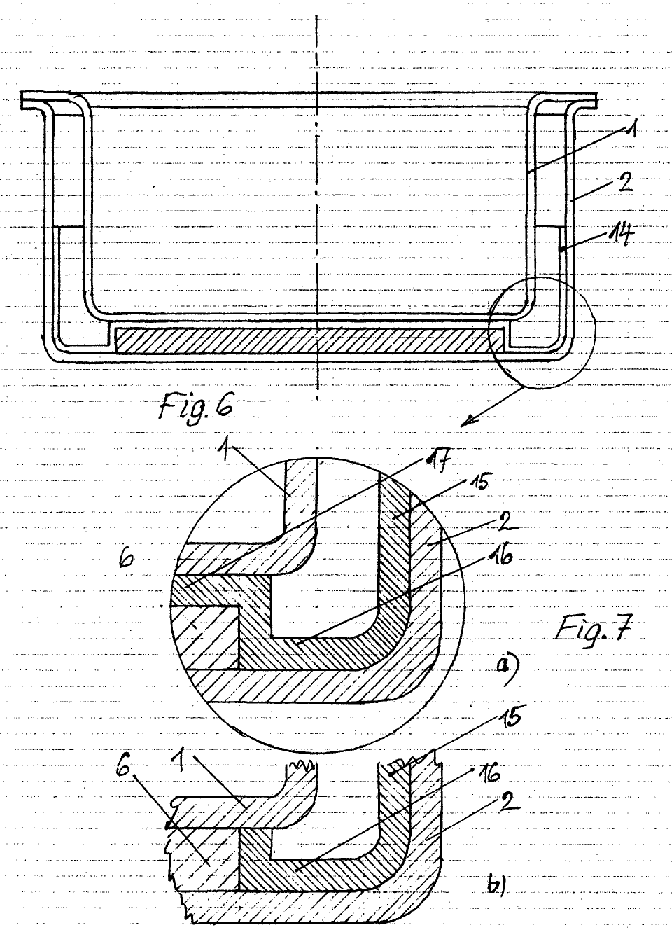

FIG. 6 an embodiment with an electro-magnetical shield,

FIG. 7a/b detail variations of the shield shown in FIG. 6.

The most important feature of the cooking vessel according to the invention is the role of the vacuum with the simultaneous realisation of the cooking vessel bottom and the cooking vessel wall. By the effect of the vacuum all the components of the cooking vessel bottom are held together. At the same time the vacuum acts in a double wall of the cooking vessel. The thus generated bottom is particularly efficient fur the heat transport into the interior of the cooking vessel, e.g. to the water. The double wall on the other hand effects a an extremely efficient heat insulation, i.e. the heat dissipation of the cooking vessel to the ambient air is minimized to such an extent that almost equal heat technological conditions are achieved as with a so-called thermos flask. The simultaneousness of the effect of the vacuum makes the cooking vessel according to the invention particularly attractive with regard to costs and production.

A further property of the cooking vessel resides in the possibility leading to a temperature-guided control during cooking. The miniaturized electronics with suitable temperature sensors may be arranged in the wall of the cooking vessel with wireless transmission of the measuring values to a regulator connected to the heat source. The actual technology cannot offer a control. It uses a simple steering and tries to simulate the cooking processes as good as possible. At best one may imagine the difference between control and steering in that by control a temperature level in the product to be cooked is given and after reaching the level is held. Steering is a solution which does not function without human assistance. If a cooking process is to be upheld, one chooses by varying the power steps, e.g. between 1 and 10, the one which is optimally useful. Upon every influence from outside it is necessary to adapt the chosen level. Cooking is nowadays always characterized by an approximation to a condition considered as appropriate. Every incorrect procedure in cooking is immediately punished, too much heat, i.e. steam costs money and makes the cooking energetically rather inefficient. This could be replaced by the possibility of a control. Energy-efficient cooking is only possible be temperature-guided control.

For producing the cooking vessel according to the invention the production sequence needs a rearrangement. The production steps of a conventional operation are arranged as follows: deep-drawing, beveling, cleaning, preparing for the bottom connection, bottom connection, check of the bottom connection with correction if necessary, mechanical treatment (grinding and polishing), attachment of the handles, cleaning and packing. All these technological steps are used in the production of the cooking vessel according to the invention, but in a somehow varied and reduced sequence.

For producing a cooking vessel according to the invention two raw bodies have to be deep-drawn, one with a smaller diameter and one with a wider diameter. Thereafter follows the beveling and cleaning. These production steps remain unchanged as regards the sequence. The next step is the assembly of the cooking vessel.

One or several circular discs are disposed into the wider outer body. Then follows the insertion of the smaller inner body. The next step is the connection of the bodies. This is preferably done in a vacuum chamber with subsequent welding of the pouring rims of the two bodies. The purpose is to generate a vacuum in the space between the two bodies. At the removal from the vacuum chamber and entry into atmospherical pressure the bottom parts are pressed against each other, so that a good connection of all contact surfaces is achieved. The vessel wall is sufficiently strong to withstand a mechanical deformation resulting from the effect of pressure forces. As a rule the vessel wall should not gt into contact with each other. Should this happen however, it would not reduce the quality of the cooking vessel. The vacuum, which is used here, is defined as raw vacuum in the respective technical field. A vacuum higher than a few millibar is not necessary.

The remaining production steps follow unchanged as with the conventional production.

As shown in FIG. 1 the cooking vessel according to the invention is made up of two bodies, inner body 1 and outer body 2, whereby the term “body” connotates a deep-drawn raw body in the shape of a pot. In the entire intermediate space 3 between the two bodies exists vacuum. Preferably, the diameters of the bodies should correspond to the valid standards. This would avoid investment costs for the deep-drawing tools.

With the cooking vessel according to the invention only the pouring rims 5 are connected material-bonded to each other, e.g. by welding, and in the intermediate space 3 exists vacuum. The nature of the material-bonded connection is of secondary importance. After a sufficient vacuum is reached in the intermediate space 5 between the bodies 1 and 2, the pouring rims may be connected to each other. For this purpose there are various methods available, such as laser welding, electron beam welding, electro resistance welding, soldering, electro-magnetic pulse welding and many more material-bonded connection methods. Of all these bonding methods it is to be expected that after the welding the vacuum in space 3 in the double wall is not lost and will last for a very long time. A connection method such as the electro-magnetic pulse welding should preferably be used for cost reasons, because the energy costs for this bonding method are less than one cent.

In the bottom region the surfaces are pressed against each other due to the vacuum. The one or several circular bottom discs 6 present in the bottom 4 may freely move in radial direction as a consequence of being heated, because they are not material-bonded to the bottom region of the two bodies. This fact significantly contributes to the effect that the bottom 4 is altogether less deformed than in the case that all the components would be connected fixedly, i.e. material-bonded, to each other. By the vacuum in the double wall it is guaranteed that the heat loss of the cooking vessel is reduced.

Considered under technological and cost-related aspects the connection in the bottom is substantially simpler and significantly cheaper than conventional methods. As this step is a pure cold procedure, the subsequent mechanical treatment is cheaper as well. The surface treatment is reduced to polishing only. The elaborate grinding of coloured bottoms 4 due to tempering is obsolete. If the almost 500 centigrade hot vessel bottom is shock-cooled in a water bath a thin hard layer is generated, which has to be removed with increased elaboration. With the solution according to the invention this elaborate mechanical treatment of the bottom is obsolete.

The cooking vessel according to the invention, as described above, is suited for all heat sources including induction, radiation, halogen, mass cooking plates, gas and even open fire.

In this sense one may call it a universally usable cooking vessel. In the chnical field it is called an all-stove cooking vessel.

In overall regard the solution according to the invention is more energy efficient than those with conventional bottom. In particular the actually rather high costs for the bottom configuration are reduced. A relatively small vacuum chamber with e.g a laser need much less energy for realizing the bottom 4. It is not to be underestimated that the vacuum in the double wall does not have to be prepared in addition. The vacuum enables the realization of the bottom 4 and its presence in the space 3 at the same time. Thus, with the vacuum two issues are realized in one production step, resulting in advantages with regard to time and costs.

Instead of assembling in a vacuum chamber it is also possible to generate a vacuum in the intermediate space after the assembly. For this purpose a bor is provided at a location of the wall, through which the air is sucked off and which is then closed vacuum-safe.

Due to the bottom connections by vacuum it is possible to use a great variety of materials, even those, which conventionally cannot be materially-bonded. They encompass various composite materials, graphite and graphite composites, suitable ceramics, as well as various metals which for certain reasons cannot be material-bonded.

Preferably such materials are used as circular bottom disks 6 which enable a good heat transport into the interior of the cooking vessel.

In an extreme event, in which the bottom plate could melt due to high temperature, e.g. aluminum, the construction, i.e. the outer body of the cooking vessel, prevents the molten material from getting to the outside. Thus the possible subsequent damages of such an accident are diminished to a great extent.

The advantages of the solution according to the invention reside not only in the area of production, e.g. the shorter production time and lower production costs but also in its use-specific properties. The cooking vessel is more energy efficient than conventional cooking vessels. It is distinguished by shorter pre-cooking time and lower temperatures of the glass-ceramics if used with radiation heating. With induction it is less noisy and generates much less radiation scattering which as is known is harmful for humans. By choosing suitable materials for the bottom plates, e.g. aluminium, copper, graphite and other materials, a very good temperature distribution can be achieved regardless of the nature of the heat source.

The cooking vessel according to the invention can also be used in combination with the new so-called conduction cooking system. To this end preferably a bottom plate of copper or a copper alloy should be used to achieve an outstanding temperature distribution in the bottom.

The constructive configuration of the solution according to the invention allows the use of various materials for both the outer body 2 and the inner body 1. These materials have to be suitable to be deep-drawn. For the materials for the inner body 1 as opposed to the outer body a nutritional compatibility is required in addition. This is a an important prerequisite for fulfilling the valid standard EN 12983-2 for cooking vessels. For the inner bodies 1 preferably refined steel, aluminium, titanium etc. are used. As material for the outer bodies 2 refined steel, aluminium, titanium, copper and copper alloys, glass, suitable ceramical materials and plastics, as well as suitable composite materials are used.

In case that the bodies made of different materials cannot be material-bonded at the pouring rim, they must be connected in another way. The nature of this connection is secondary as long as the vacuum is upheld for a long time.

In the embodiment shown in FIG. 2 a bottom intermediate space 7 is provided below the bottom plate 6 in which vacuum is present as well. The presence of vacuum in the bottom region prevents the heat exchange between the warmer inner body 1 and the cooler outer body 2. As the inductive heat is generated in the induction-suited inner body 1, it cannot flow outwards because the bottom intermediate space 7 also stand under vacuum. In an energetic sense this is extremely positive and makes the cooking vessel particularly energy efficient. However, this cooking vessel is not all-stove but only induction suited. In view of the increasing market presence of induction this is not a disadvantage.

The inventive cooking vessel according to FIG. 2, i.e. the cooking vessel which can only be used with induction reaches an even higher energy efficiency and shorter pre-cooking time as compared to the all-stove version according to FIG. 1. The physics behind that is easily to understand: The glass ceramics gets less hot and the heat losses of the bottom get smaller. The amount of heat generated inductively flows almost exclusively to the “customer” in the cooking vessel (products to be cooked, water, oil etc.) and not where it is not needed.

A similar effect is reached if the space 7 in the bottom region 4 is filled with a thermo insulation material.

FIG. 3 shows schematically a cooking vessel according to the invention with integrated electronics and a sensor unit for a temperature-guided control of a cooking system with induction as heat source. The two previously described versions of the cooking vessel according to the invention are suitable for a temperature-guided control of the cooking process. The elctronis 8 needed for the control is arranged in the vessel wall of the cooking vessel, preferably at the cooler outer wall. A temperature sensor 10 is directly connected to the inner body to detect the effective temperature of the products to be cooked or the water etc. As exactly as possible. Normally, the sensor will be a commercially available temperature sensor such as Pt-resistors, thermo elements etc. Which transmit their measured values to the electronics 8 in the double wall which in turn transmits them wireless to an electronics of the cooking field. The energy needed for the measurement, evaluation and transmission of the signal is provided by a micro coil in the induction cooking field 11.

Thanks to the control the cooking, especially during the actual cooking phase extremely energy efficient. There is only so much heat supplied to the cooking vessel as it transfers to the ambience without lowering the temperature of the content of the cooking vessel. This shows clearly the advantage of the control of the cooking process.

In the embodiment shown in FIG. 4 the outer body 2 is provided with a recess in which an additional lower bottom plate 12 is inserted. This bottom plate is vacuum-tight connected to the outer body, foe example by a seal made of silicon caoutchouc. This additional bottom plate is inserted after the deep drawing. For this bottom plate materials with high specific electrical resistance are suited, i.e. for example ceramics and their composites, glass ceramic, glass, plastics etc.

On an induction cooking field this construction prevents the electric field from closing in the bottom region so that the outer body is not heated.

If the lower bottom plate consists preferably of a material with high IR light transparency the cooking vessel can also be used with radiation heating. Due to the low absorption of the lower bottom plate this will be heated only minimal, whereas the main portion of the IR radiation is transformed into heat in the upper bottom plate 6 and is immediately transferred to the products to be cooked.

As an IR light transparent material preferably glass ceramics with high transparency is considered. This material in addition has a high stability, high temperature durability and very high temperature shock stability. With this many requirements which are expected from a cooking vessel can be fulfilled.

Between the upper and the lower bottom plate distance holders 13 are provided. They serve to keep the contact between the two bottom plates in order that the effect of the vacuum exists. The distance holders may e.g. consist of protrusions on the surface of the lower bottom plate. The dimensions of a typical bottom configuration is as follows: For the upper bottom plate 6 a thickness of 0.5 mm would be sufficient for the heating by means of induction. Preferably, however, a thickness of 2 to 3 mm is used. For the lower bottom plate 12 a thickness of 3 mm is preferably suited as well. The distance between the two bottom plated is preferably 1 mm. Variations of these dimensions are possible.

The embodiment shown in FIG. 5 is equally provided with a lower bottom plate 12 inserted in a recess of the outer body, which is provided with the control elements of the embodiment shown in FIG. 3.

The two bodies may also be multi-layered, whereby the layers preferably consist of different materials. The layers do not have to be material-bonded to each other.

If the inner body consists of a layer of refined steel on the side of the products to be cooked and an additional layer of a material with a good heat conduction on the vacuum side, such as aluminium, this has the effect of an improved radial heat distribution in the bottom region and a lower heat dissipation towards the outside in the wall region, i.e. in direction of the vacuum or the outer body.

For the outer body an additional layer with good heat conduction at the vacuum side is advantageous as well, because due to its shielding effect the heating of the austenitic outer layer is prevented or reduced. Especially in the region of the curvature between bottom and wall regions too much heating during induction cooking is thus avoided.

A corresponding embodiment is shown in FIGS. 6 and 7. In addition to the elements described up till now, an electro-magnetic shielding 14 is provided between the inner and outer body. This shielding consists preferably of aluminium. Other materials with similar properties as aluminium may also be used.

As the two bodies the shielding also has the shape of a pot with bottom and wall regions. But the cylindrical wall region 15 of the shielding extends only over a part, e.g. half, of the overall height of the wall. The bottom region of this embodiment is formed such that it has an outer annular portion 16 which contacts the outer body and an inner bottom portion 17 corresponding to the bottom plate 6 and being recessed such that it includes the the bottom plate 6 and that its flat portion is positioned between inner body and bottom plate.

The most important function of the shielding is to eliminate the effect of the electro-magnetic field in order to avoid heating of the outer body in the region between its bottom and its vertical portion. The vacuum in the intermediate space, i.e. in the space between the two vessel bodies has an infinitely high electrical resistance so that the electrical field would be closing and heating everything within (Joule's law). This amount of heat would very badly be transferred to the inner body and would cause very high temperatures and damages of the cooking vessel. This is prevented by the shielding at the inner surface of the outer body.

An important prerequisite thereby is that the two part are in contact. There must be no significant gap between the outer body and the shielding. Otherwise the outer body would be heated as without the shielding.

The electro-magnetic shielding may also be configured annularly as shown in FIG. 7b, i.e. without the bottom region 16. But the effect of the electro-magnetic field in the interior of the cooking vessel, the version with the bottom portion is preferred. A direct “contact” between the electro-magnetic field and the products to be cooked should be avoided. If the shielding is configured without the bottom potion, other measures are known as such to prevent the distribution of the electro-magnetic field in the interior of the cooking vessel.

A further advantage of the shielding resides in the fact that it serves simultaneously for the centering of the bottom plate and keeps the bottom portions of the outer and inner bodies in full surface contact with the bottom plate.

1. Double-walled cooking vessel with an inner body and an outer body being arranged into each other with a distance in between, the bodies having a flat bottom portion and a wall portion, and with a bottom plate arranged between the bottom potions of the two bodies, characterized in that the two bodies are connected with each other in a vacuum-tight manner and that a vacuum exists in between.

2. Cooking vessel according to claim 1, characterized in that the bottom plate is multi-layered.

3. Cooking vessel according to claim 1, characterized in that a distance exists between the bottom plate and the bottom portion of the outer body.

4. Cooking vessel according to claim 1, characterized in that the bottom portion of the outer body has a recess into which an additional bottom plate is inserted in a vacuum-tight manner.

5. Cooking vessel according to claim 4, characterized in that the additional bottom plate consists of a material having a high specific electrical resistivity.

6. Cooking vessel according to claim 1, characterized in that in the wall portion a temperature sensor and a transmitting device are arranged for transmitting a temperature signal to a control unit in the heat source.

7. Cooking vessel according to claim 1, characterized in that one of the bodies or both are configured in a multi-layer manner.

8. Cooking vessel according to claim 7, characterized in that the layers at the side of the vacuum consist of a material with high heat conductivity.

9. Method of producing a cooking vessel according to claim 1, characterized in that the assembly of the bodies and the bottom plates is made in a vacuum chamber.

10. Method of producing a cooking vessel according to claim 1, characterized in that after the assembly of the bodies and the bottom plates a vacuum is generated in the intermediate space.
